(19) United States
(12) Patent Application Publication
(10) Pub. No.: US 2026/0305676 A1
(43) Pub. Date: Oct. 8, 2026

(54) DEVICE FOR PRODUCING ASSEMBLED PRODUCTS

(71) Applicant: REET Systems Gmbh, Wien (AT)

(72) Inventor: Dieter SPRANZ, Oberwaltersdorf (AT)

(73) Assignee: REET Systems Gmbh, Wien (AT)

(21) Appl. No.: 19/482,192

(22) PCT Filed: May 8, 2024
(86) PCT No.: PCT/AT2024/060198

§ 371 Date: Nov. 6, 2025

(30) Foreign Application Priority Data
May 9, 2023 (AT) A50353/2023

(51) Int. Cl. A23P 20/20

(52) U.S. Cl. CPC A23P 20/20

(57) ABSTRACT

A device for producing assembled products (10) is provided herein. Such devices can include a transport means (1) and multiple storage containers (5) for ingredient types, each having a separating and a positioning unit (6) for an ingredient type along the transport means (1). The device can include an electronic control unit with pre-installed product offers, which differ in terms of differing combinations of ingredients by means of which orders can be executed by means of method steps of the device and by means of which the method steps can be monitored. The transport means (1) can include sections (2), the respective beginning and ends of which adjoin one another such that a product to be assembled is transferred linearly from one section (2) to an adjacent section (2), wherein each sections (2) can be controlled independently, and each separating and positioning unit (6) is assigned its own section (2).

The invention relates to a device for producing assembled products, comprising a transport means, a plurality of storage containers for ingredient types, each having a separating and positioning unit for an ingredient type along the transport means, an electronic control unit with pre-installed product offers, which differ in terms of differing combinations of ingredients by means of which orders can be executed by means of method steps of the device and by means of which the method steps can be monitored.

In the field of composite goods production, particularly for layered products, devices are known which mechanically perform partial steps of assembly, such as warming and dispensing a piece of dough, dispensing a portion of a topping, and the like, in order to make production more cost-effective or faster.

WO 2020/227723 A1 shows a sandwich machine in which pieces of bread are placed and topped in an endless chain of storage tubes. Each sandwich ingredient must be refilled in its own way.

EP 3504976 A1 and U.S. Pat. No. 5,365,835 disclose devices for dispensing toppings for baked goods, which are stored in standardized storage containers above a conveyor belt and dropped onto a preliminary product when needed. However, important preparation and finalization steps for dishes must be carried out by hand.

KR 101852274 B1 describes a machine for producing baked goods with rotating magazines that hold individual layered ingredients of a hamburger on different planes and lower them onto a burger pre-product when electronically controlled. The machine can only produce a small number of burgers before it needs to be serviced.

The purpose of the invention is to provide a device for assembled products with higher efficiency. Maintenance should be more cost-effective, hygiene requirements easier to meet, and production costs for the assembled product and for the machine low. The solution should be easy to use and not prone to malfunction. Finally, the solution should also be space-saving in terms of the length, width, and height of the device. Another advantageous aspect of spatial practicality is that the device must be accessible from few sides, both during operation and maintenance.

The device according to the invention achieves this by the fact that the transport means is composed of sections whose respective beginnings and ends adjoin each other in such a way that a product to be assembled can be transferred linearly from one section to an adjacent section, wherein each of the sections can be controlled independently, and wherein each separating and positioning unit is assigned its own section.

An advantageous embodiment is characterized in that it has a storage container for a product base and a separating and positioning unit for the product base, wherein the separating and positioning unit is arranged at a starting position of the conveyor belt. This means that food is transported more hygienically on the means of transport. In addition, it is possible to produce a dish together with its intended packaging, in such packaging, or in outer packaging in one and the same device.

Furthermore, in a modification of the device, the product base is a tray-like box, and a printer is provided to print on a box that has been removed. This allows the dishes to be better protected, identified, and provided with accompanying information.

It is also conceivable that at least two storage containers are provided for two different product bases, which can be selected alternatively by the separating and positioning unit depending on the control. This will expand the range of products on offer.

Furthermore, in a modification of the device, a removal compartment is arranged at the end of the transport means, in particular at least two removal compartments, upstream of which a transport switch is arranged in order to easily perform a regular and necessary action in connection with assembled dishes.

It is also conceivable that at least two of the ingredient types are available in at least two varieties. This will expand the range of products on offer.

With an alternative, at least one ingredient type can be selected optionally in order to increase the range of products on offer once again.

In one alternative, the device comprises storage containers for ingredient types in the form of ingredients for assembled dishes. This means that the device is experiencing higher demand on the markets.

An advantageous embodiment is characterized in that it comprises at least storage containers for: cardboard boxes, baked goods, sauces, tomato slices, lettuce pieces, to cover the most important ingredients for dishes.

Furthermore, in a modification, it comprises a toaster unit for a type of food that has been removed, in particular for sandwich bread halves or slices of toast, so that the assembled dish is warm and ready to eat immediately upon completion.

It is also envisaged that it will include an electronic ordering system through which orders for assembled dishes can be received via an interface in which orders can be stored and through which orders can be transferred to the electronic control unit. This increases efficiency.

In one alternative, storage containers can be replaced individually so that efficiency is not compromised by having to pause the entire device as soon as the supply of an ingredient is used up.

An advantageous embodiment is characterized in that the storage container, separating and positioning unit, and ingredient section are combined in a modular manner such that they can be moved together from the device into a test position to facilitate maintenance.

Furthermore, the means of transport or one or more sections thereof can be heated. This allows the dish to be kept warm at a predetermined temperature or brought to a predetermined pre-temperature that is required or desired when removing the dish from the device.

The invention is explained in more detail below using an exemplary embodiment shown in the drawings. Only the claims provide information about the optional nature of individual features and protected embodiments.

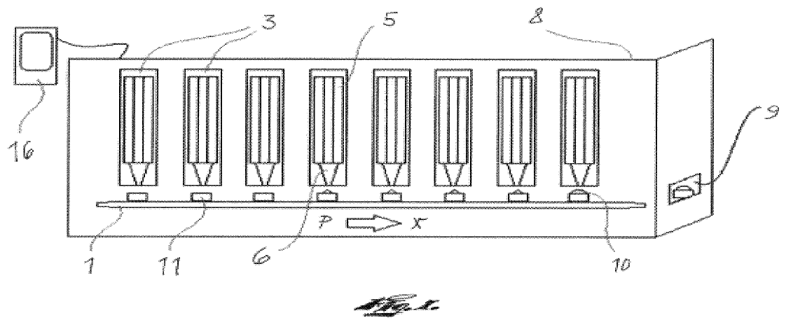

FIG. 1 shows a schematic overview of the device,

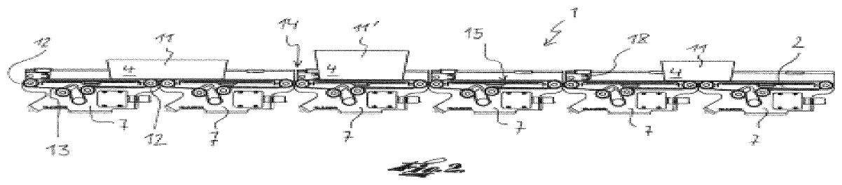

FIG. 2 shows a section of the transport means, and

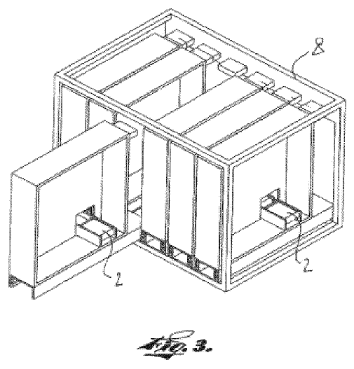

FIG. 3 shows a schematic perspective view of a section of the device.

According to FIG. 1, the step-by-step preparation of an assembled product 10, such as pizzas and sandwiches, is reflected in a series of stations lined up along a transport means 1. The preparation method is therefore divided into steps, each of which is carried out in an assigned assembly 3. Thanks to special design features, the device according to the invention can operate in a vending machine 8 in such a way that the assembled product 10 can be produced from the first ingredient to completion and stored ready for consumption. In addition, the vending machine 8 can produce a range of different dishes without requiring any structural modifications or adjustments by staff.

The transport means 1 can be a conveyor belt. Alternatively, it can be any other conveying device or transport unit, such as a magnetic levitation device, in which storage plates can be moved and held in a linear, rotary, and/or tiltable manner within a certain angle range above an electronically controlled magnetic levitation table.

The transport means 1 moves (in the case of a conveyor belt) or storage plates (in the case of a magnetic levitation device) depending on an electronic control unit that receives orders for dishes, sends commands with processing steps to the assemblies 3, and monitors the production progress of the products 10 in a predetermined production direction P, which is defined as the positive x-direction.

In the example shown, a product base in the form of box 4 is first placed on transport means 1. Below the next assembly 3, the first ingredient is placed in the box, and so on, until the assembled dish is completed at the end of the transport means 1.

An assembly 3 is designed and dimensioned according to the type of ingredient. In most cases, it includes a storage container 5 with as large a number or quantity of an ingredient as possible. The larger the capacity of the storage container 5, the less frequently it needs to be refilled, which is an action that would have to be performed by human hands. However, the capacity of a storage container 5 must not be too large for the specific ingredient, so that the ingredient does not lose quality in terms of temperature, moisture, freshness, aroma, and the like due to too long a storage time in the storage container. It is therefore necessary to determine the optimal size of the storage container 5 for each ingredient, as well as the type of storage, such as refrigerated or preheated.

In addition, in most applications, an assembly 3 comprises a separating and positioning unit 6. This is a device that can be constructed by a specialist, usually a mechanical device, which removes an ingredient in the appropriate quantity from the storage container 5 and places it on the dish to be assembled, which is located below the separating and positioning unit 6. The separating and positioning unit 6 must also be adapted in design to the ingredient for which it is intended and is shown only symbolically in FIG. 1. It takes on different shapes for different ingredients such as piece goods, granular goods, pasty goods, soft goods, moist goods, slice-shaped goods, etc. The same applies, of course, to the storage containers 5, which are only shown symbolically here.

The transport means 1 is a linear belt lying in the x-direction, which allows the device and the vending machine 8 to be designed in a space-saving manner. Mechanical parts, e.g., assemblies 3, are designed to be narrow in the x-direction and deviate into the dimensions above and behind them to create the necessary space for storage containers, control units, and separation.

The transport means 1 is composed of sections 2 as shown in FIG. 2. A section 2 can be a short conveyor belt or a short section of a magnetic levitation device. The invention is described below using the non-limiting example of a conveyor belt.

Each section 2 can, for example, consist of a closed belt section 13 running on at least two rollers 12, which can be driven and stopped independently of the other sections 2. The end of a section 2 directly adjoins the beginning of a directly adjacent section 2, except for a gap 14 that exists for reasons of operational safety and maintenance safety. The arrangement of all sections 2 forms the entire transport means 1 with a common transport plane 15 (upper side of the sections 2), on which a product base 11 can be moved in the x-direction linearly from the beginning to the end in a uniform, stepwise, or partially accelerated or decelerated manner.

Boxes 4 can be used as product base 11; these boxes do not need to be the same size, without this having any adverse effect on the functioning of the device. The length of a section 2 in the x-direction can be dimensioned so that it corresponds to the length of a box 4. Box 4 may have a hinged lid that increases the overall length during assembly, in many cases even doubling it. The length of section 2 can also be determined based on this greater length so that the lid of a box 4 on a first section 2 does not extend into the working area of an adjacent section 2.

FIG. 2 shows six sections 2 that are all the same length. This has the advantage that a standardized model of section units can be used, exchanged, maintained, and controlled. In accordance with the unit length selected in this way, other important parts of the vending machine 8, e.g., assembly 3, storage container 5 or groups of storage containers 5, or removal and positioning units 6, can also be designed uniformly in terms of their external dimensions or dimensions along the x-direction. Greater flexibility with almost the same advantages as the standard length is achieved by ensuring that the length of the sections 2 in the x-direction is an integer multiple of the standard length, e.g., 2 times, 3 times, or 4 times.

Each section unit 7 has an electric drive and can be equipped with a sensor 18 whose detection range is directed toward the transport plane 15 and detects the arrival, presence, and departure of a product base 11, 11′ and reports this to the central electronic control unit. The sensor 18 is, for example, an optical sensor, an ultrasonic sensor, or an infrared sensor.

The transport plane 15 of the sections 2 naturally deepens at the rollers 12, or is interrupted there. The rollers 12 of two sections 2 therefore form a depression, which, however, is so small due to the appropriate choice of roller diameters that a pre-known box 4 with a certain length in the x-direction does not tip into the depression or become jammed.

In this way, the electronic control unit moves an assembled product 10 on or in a product base from one assembly 3 to the next assembly 3 on the respective sections 2 until the dish is complete and has reached the end of the entire transport means 1.

In most cases, section 2 rests for a moment with a product base 11′ stationary in its center in the x-direction, together with the assembled product 10 (not visible in FIG. 2), because there is an assembly 3 for an ingredient above section 2, which has to dispense a partial quantity onto the product 10 during this resting period. In some cases, the product base cannot or should not come to a complete standstill during this method step, but should continue to move slowly.

When transferring a product base 11 from one section 2 to the next section 2, both sections 2 involved are controlled so that they assume the same or a similar transport speed. The product base then moves from the first section 2 to the next without interruption or unwanted disruptive movement or acceleration in other directions within the room. This is a method step that is repeated many times during the preparation of each assembled dish.

It is now particularly advantageous that certain movement patterns of the sections 2 can be combined along the entire length of the transport means 1 in order to increase the production capacity of the device, improve the production quality, or even enable certain method steps.

This means that a section 2 with a product 10 on it can remain stationary for a period of time, while other dishes
(i) simply continue on their way elsewhere on the transport means 1,
(ii) are transferred to the next station,
(iii) are completed at another station,
(iv) pass through a station unchanged,
   or similar.

Secondly, transfer steps between two adjacent sections 2 can be carried out independently of the movement status of all other sections 2 of the transport means 1.

Thirdly, a product 10 can move back and forth on a section 2 in the x-direction in a predetermined manner for the method step of applying an ingredient, e.g., in order to apply a free-flowing ingredient more evenly. Other sections 2 can perform different movement patterns to further process other assembled dishes. This independence of movement between the sections 2 increases the efficiency of the device.

Fourthly, it is conceivable that an assembled product 10 must be moved one or more stations in the opposite direction to the (positive) x-direction for a specific installation step within a certain period of time, in order to then be moved back the same distance in the x-direction and finalized. According to the invention, it is not necessary to move the entire transport means 1 back and forth, but only a few sections 2 thereof. Therefore, other movements may take place in other sections of transport means 1, e.g. if further dishes are being processed in front of and behind it and cannot be moved backwards temporarily in a sensible manner.

The device allows the assembled dish to be created entirely on a product base such as a plate, tray, or box 4. Higher hygiene requirements are met, as products and ingredients do not come into contact with the sections 2. This is particularly desirable when it comes to food. In addition, a dish is created that is already prepared or even fully equipped for the next step, namely removing the dish from the device and transferring it to a serving tray, into a carrier bag for “to-go” orders, or directly to the customer. The packaging step is therefore omitted entirely or partially. For pizzas and sandwiches, the product base can be a box 4, such as a cardboard box, which carries its lid with it when open. A component of the device at the end of the production line can close the lid automatically. Alternatively, the closing process can be performed manually, allowing for a visual inspection of the assembled dish.

The assembled product 10 on the product base is transferred at the end of the production line—i.e., after the last section 2—to a removal compartment 9, where it can remain visible, easily accessible, and stationary until it is removed by another automatic device or by hand. The removal compartment 9 can be a window or a recess in the outer shell of the device, wherein the assembled dish, including, for example, box 4, slides from the last section 2 onto a horizontal storage surface, slides onto a slightly inclined surface, is lifted into the removal compartment 9 by support arms or a lift, or similar.

Depending on the size of the products and the removal compartments 9, it is also conceivable that two or more removal compartments 9 are provided so that further finished dishes can be parked for removal without one or more dishes finished before them already having to be removed and their removal compartment 9 having to be vacated again. A removal compartment 9 can also hold a row of ready-made dishes, such as a row of three to ten products 10 in a box 4. Alternatively, finished products can be stacked in removal compartment 9 using a stacking unit (not shown).

The electronic control unit receives data from a sensor regarding the occupancy status of the removal compartment(s) 9, so that finished dishes are only parked when a position is free.

The electronic control unit also receives status data on numerous other parts of the device, such as the fill levels of all storage containers 5, the operating status of the separating and positioning units 6, the movement statuses of all sections 2, the occupancy status of the sections, and the operating status of supplementary units such as cooling systems. It accepts specific orders for the production of a dish, a number of dishes, or a range of different dishes, wherein a product offer of one or more assembled dishes with the corresponding production steps is stored in it along the transport means 1. The control unit can temporarily mute product offers of certain dishes if the corresponding storage containers 5 are empty. It can send signals to staff to remove finished products 10, fill storage containers 5, clean separating units 6, and maintain parts of the device.

Finally, the electronic control unit can collect and store device data, such as quantities and order times for dishes, maintenance cycles, etc., in order to increase efficiency or enable insights to be gained from operating data.

When the electronic control unit displays the fill level of individual storage containers 5, it is advantageous if the storage containers 5 can be refilled and/or removed from the device without affecting or interrupting the other storage containers 5, other assemblies 3, and other separating and positioning units 6. A specialist can routinely solve the design task of creating storage containers according to specified ingredients and providing separate access to the device via doors, lids, pull-out mechanisms, etc.

Assemblies 3 can also be moved individually out of the entire device. Depending on the design, the assigned section 2 may be structurally connected to assembly 3 or remain static on the device.

A small number of assemblies 3, such as five, with respective sections 2 may be sufficient to realize the advantages of the invention. It is also conceivable that, for example, 15 assemblies 3 are provided with 15 sections 2, wherein many of the assemblies 3 can provide several alternatives of their ingredient or, in some dishes, do not provide their ingredient, in order to be able to offer and produce a considerable number of different assembled dishes in the range.

The arrangement of assemblies 3 along the x-direction on or above the transport means 1 can advantageously be selected such that the first assembly 3 reached dispenses the product base, the second assembly 3 dispenses the bottom ingredient of a layered dish, and so on, until the last assembly 3 is intended for dispensing the top ingredient. However, assemblies 3 can be mounted interchangeably in the device in order to optimize the device for other dishes.

Secondly, however, a sequence of assemblies 3 that is not optimized for a particular dish can be compensated for by the dish temporarily moving in the device in the opposite direction to the (positive) x-direction in order to obtain one or more ingredients once or twice without having to rebuild the device as a whole or remove the dish from the menu. This may be the case, for example, if the dish is to be offered in addition to other dishes and the device is optimized for the other dishes in terms of the arrangement of the assemblies 3.

In addition to soups, bowl dishes with rice or other ingredients, stews, tacos, sandwiches, burritos, and sweets, the device can also be used to make pizzas, as demonstrated here using an example:

In a fast food restaurant, many employees are busy offering a range of different pizzas and preparing them in the kitchen under time pressure when customers place their orders. Pizzas, sandwiches, and other assembled dishes are particularly suitable for realizing the advantages of the device, as they are essentially products assembled by layering from above. The device can now offer a comparable range of products and produce orders in less time and with less human labor. To achieve this, it has successive assemblies 3 for
boxes 4 in two or more sizes,
pizza dough patties,
tomato sauce,
tomatoes, olives, lettuce and onions,
salami, ham and variations thereof,
cheese in, for example, two different sizes or two different types.

Boxes 4 and dough patties may also be present in elongated form in the respective assembly 3 and/or their storage container 5 as an alternative, without the device requiring any adjustment. Since, in addition to ingredient variations, round pizzas, sandwiches, or elongated pizzas, pide, or sandwiches and the like can also be produced, the range of products on offer is greatly increased once again.

Furthermore, assemblies 3 can be arranged at suitable positions in the device for
pepper and/or salt and/or herb
ingredients that are used for a limited time, e.g., as additional toppings (so-called limited-time offers).

Although a complete assembly process should not take much time, it may be desirable to maintain a predetermined temperature of the dish or to continuously increase the temperature during assembly. Legal requirements for the processing of food and dishes may also have to be observed, which include upper and lower temperature limits. In a simple case, an assembled dish should be warm or hot at the time of completion, as is customary in the catering industry. To enable this, the transport means 1 or one or more sections 2 thereof can be heated. This can be achieved by means of heating devices or radiant heaters that heat the conveyor belt itself or a storage table. Alternatively, areas above the transport plane can be covered by heating devices. All such solutions are advantageous because the temperature can be precisely controlled and monitored locally and temporally, which saves energy and/or time.

In this example, customers can use their smartphone or an interface in the fast food restaurant to place an order, for example for a “salami” pizza, which is interpreted as an order by the electronic control unit and converted into instruction steps for the device. In the first assembly 3, a box 4 corresponding to the order is removed from the storage container 5 by the separating and dispensing unit 6 and placed on the beginning of the transport means 1, namely the first section 2, which is assigned to the first assembly 3.

The box continues to move in the x-direction on the respective sections 2 until it reaches assembly 3 for the dough patties, where, depending on the order, for example for the production of a “salami” pizza, the appropriate variety is taken from storage container 4 and placed in box 4, which is resting on section 2.

This process continues step by step, with the box 4 stopping briefly or slowing down under each assembly 3 and picking up the next predetermined ingredient to create a “salami pizza.” Box 4 passes through some assemblies 3 because the ingredient in this assembly 3 is not needed for a pizza such as “salami,” for example. The sections 2 on which box 4 is not located at a given time or to which box 4 will not be transferred in the near future may be in other movement states, primarily in order to process other orders.

After passing through all assemblies 3 on sections 2, the box containing the “salami” pizza, which has been completed by adding basil leaves, for example, arrives at the removal compartment 9, whereupon the electronic control unit emits a visual and/or acoustic signal indicating to the staff that the “salami” pizza is ready to be handed over to the customer who ordered it.

The device is equally suitable for product offering and producing a range of sandwiches.

The device may contain units for improving or preparing ingredients and product parts, which are appropriately assigned to their assembly 3, namely printers for box 4, cooling systems, heat lamps, control cameras for quality control, for counting produced product units, or for detecting malfunctions.

### REFERENCE LIST

1 Transport means
2 Section
3 Assembly
4 Box
5 Storage container
6 Separating unit and positioning unit
7 Section unit
8 Vending machine
9 Removal compartment
10 Product
11 Product base
11′ Stationary product base
12 Roller
13 Belt section
14 Gap
15 Transport plane
16 Interface
17 Sensor
P Production direction

1. A device for producing assembled products (10) with a transport means (1), a plurality of storage containers (5) for ingredient types, each with a separating and positioning unit (6) for one ingredient type along the transport means (1), an electronic control unit with pre-installed product offers that differ in terms of various combinations of ingredients and through which orders can be executed by means of the device's method steps and through which the method steps can be monitored, characterized in that the transport means (1) is composed of sections (2) whose respective beginnings and ends are adjacent to each other in such a way that a product to be assembled can be transferred linearly from one section (2) to an adjacent section (2), wherein each of the sections (2) can be controlled independently, and wherein each separating and positioning unit (6) is assigned its own section (2).

2. The device according to claim 1, characterized in that it has a storage container (5) for product bases (11) and a separating and positioning unit (6) for a removed product base (11), wherein the separating and positioning unit (6) is arranged at the beginning of the transport means (1).

3. The device according to claim 2, characterized in that the product base (11) is a tray-like box (4) and that a printer is provided to print on a box (4) that has been removed.

4. The device according to one of claims 2 or 3, characterized in that at least two storage containers (5) are provided for two different product bases (11), which can be selected alternatively by the separating and positioning unit (6) depending on the control.

5. The device according to one of claims 1 through 4, characterized in that a removal compartment (9) is arranged at the end of the transport means (1), in particular at least two removal compartments (9), upstream of which a transport switch is arranged.

6. The device according to one of claims 1 through 5, characterized in that at least two of the ingredient types can be selected in at least two varieties.

7. The device according to one of claims 1 through 6, characterized in that at least one ingredient type is optionally selectable.

8. The device according to any of claims 1 through 7, characterized in that it comprises storage containers for ingredients for assembled dishes.

9. The device according to one of claims 1 through 8, characterized in that it comprises at least storage containers (5) for: cardboard boxes, baked goods, sauces, tomato slices, lettuce pieces, and spices.

10. The device according to one of claims 1 through 9, characterized in that it comprises a toaster unit for a type of food that has been removed, in particular for sandwich bread halves or slices of toast.

11. The device according to one of claims 1 through 10, characterized in that it comprises an electronic ordering system through which orders for assembled dishes can be received via an interface (16) in which orders can be stored and through which orders can be transferred to the electronic control unit.

12. The device according to one of claims 1 through 11, characterized in that storage containers (5) are individually replaceable.

13. The device according to one of claims 1 through 12, characterized in that the storage container (5), the separating and positioning unit (6), and the section (2) of an ingredient are combined in a modular manner such that they can be moved together from the device into a test position.

14. The device according to one of claims 1 through 13, characterized in that the transport means (1) or one or more sections (2) thereof can be heated.
